(19) United States
(12) Patent Application Publication
(10) Pub. No.: US 2023/0126932 A1
(43) Pub. Date: Apr. 27, 2023

(54) RECOMMENDED AUDIENCE SIZE

(71) Applicant: AMPERITY, INC., Seattle, WA (US)

(72) Inventors: Yan YAN, Seattle, WA (US); Christopher James CHAPO, Seattle, WA (US); Joseph CHRISTIANSON, Seattle, WA (US); Joyce GORDON, Seattle, WA (US); Andrew LIM, Brooklyn, NY (US); Nicholas RESNICK, New York, NY (US)

(21) Appl. No.: 17/511,780

(22) Filed: Oct. 27, 2021

(51) Int. Cl. G06Q 30/02; G06F 7/02

(52) U.S. Cl. CPC G06Q 30/0204; G06F 7/026

(57) ABSTRACT

The example embodiments are directed toward improvements in predicting an ideal audience size. In an embodiment, a method is disclosed comprising receiving a set of users associated with an object attribute; selecting samples from the set of users; computing hit rates for the samples, a respective hit rate in the hit rates computed by calculating a total number of users in a respective sample associated with an interaction associated with the object attribute; and selecting a recommended sample from the samples, the recommended sample comprising a sample having an associated hit rate that meets a preconfigured hit rate threshold.

### BACKGROUND

The example embodiments are directed toward predictive modeling and, in particular, techniques for determining a recommended audience size for a given object.

Currently, the ability to predict an optimal audience size is difficult or subject to inaccuracies due to the lack of actionable information such as the cost to “acquire” a user or a drop-off rate for users associated with a given object (e.g., product). As a result, many systems provide little to no meaningful insight regarding an optimal audience size.

### BRIEF SUMMARY

The example embodiments describe systems, devices, methods, and computer-readable media for generating an optimal audience size. In the example embodiments, a system receives a ranked list of users for a given object (e.g., product) or attribute of a product. Details of generating such a ranked list are described more fully in commonly owned application bearing attorney docket number 189943-011300/US and are not repeated in full herein. In brief, the ranked list can comprise an ordered set of tuples, each tuple including a user identifier and a score related to the probability of a user interacting with a given object (e.g., an item of clothing) or object having a certain attribute (e.g., a brand of clothing).

In some embodiments, the ranked list can be significantly large (e.g., over ten million records). The example embodiments provide a mechanism to identify a portion of the ranked list that represents an optimal audience size for further operations (e.g., targeting advertisements, sending personalized communications, etc.). In general, numerous factors determine which subset of the ranked list are viable users for further operations. For example, the “cost” (both in time and money) to acquire a user versus the amount of revenue that the user is expected to contribute can determine where to segment the ranked list. That is, as the ranked list decreases in relevancy, the net revenue may be negative, indicating such users do not merit further operations. Similarly, a “drop off” rate may be instructive, the drop off rate indicating that after a certain point, the uncertainty of how valuable a user is may merit exclusion from further operations.

In general, it may be difficult or impossible to quantify characteristics such as a drop-off rate or net revenue. To overcome this difficulty or impossibility, the example embodiments utilize a proxy referred to as a “hit rate” of each user. In an embodiment, the hit rate refers to the percentage of purchases in a certain holdout period that are predicted by a predictive model. For example, a 90% hit rate indicates that the model successfully predicts 90% of purchases using a particular audience size

In an embodiment, a method includes receiving a first set of users associated with an object attribute; computing hit rates for the first set of users, a respective hit rate in the hit rates computed by calculating a total number of interactions associated with a respective user during a holdout period; fitting a curve based on a plurality of segments of the first set of users, each segment in the segments associated with an aggregate number of interactions; computing a recommended audience size based on the curve and a desired hit rate; and selecting a subset of users from the second set of users, the subset selected based on the recommended audience size and the curve.

In an embodiment, receiving the first set of users comprises receiving a ranked set of users. In an embodiment receiving the ranked set of users comprises receiving a set of users ranked by affinity group scores associated with each user in the set of users, a respective affinity group score associating a respective user to a respective object.

In an embodiment, the method can further include generating the first set of users by: separating a set of interactions into a training set and a holdout set based on a point in time; ranking a set of users based on interactions in the training set; and temporarily storing the holdout set.

In an embodiment, computing a recommended audience size based on the curve and a desired hit rate comprises: selecting a plurality of segments of the first set of users; calculating a total number of hits for each of the segments; and using sizes of the plurality segments and corresponding total numbers of hits as points on the curve. In an embodiment, selecting the plurality of segments comprises selecting the plurality of segments according to a step function. In an embodiment, the plurality or segments are overlapping and increasing in size as selected using the step function.

In some embodiments, devices, non-transitory computer-readable storage mediums, apparatuses, and systems are additionally described implementing the methods described above.

### BRIEF DESCRIPTION OF THE DRAWINGS

FIG. 1 is a system diagram illustrating a system for generating learned recommended audience sizes according to some embodiments.

FIG. 2 is a flow diagram illustrating a method for generating learned recommended affinity group of users according to some of the example embodiments.

FIG. 3 is a flow diagram illustrating a method for computing a ranked list of users according to some of the example embodiments.

FIG. 4 is a flow diagram illustrating a method for computing hit rate for a sample set according to some embodiments of the example embodiments.

FIG. 5 is a flow diagram illustrating a method for continuously updating learned recommended audience sizes according to some of the example embodiments.

FIG. 6 is a chart illustrating learned recommended audience sizes according to some of the example embodiments.

FIG. 7 is a block diagram of a computing device according to some embodiments of the disclosure.

### DETAILED DESCRIPTION

The example embodiments describe systems, devices, methods, and computer-readable media for generating a recommended audience size.

As described in commonly owned application bearing attorney docket number 189943-011300/US, an affinity group for a given object refers to a ranked list of users that are likely to interact with the object or attribute of an object. Frequently, organizations seek to determine the size of an audience required to reach a targeted number of interactions. For example, a given retailer may wish to determine how many customers should be targeted to sell a desired number of products. The size of the audience often does not equal the desired number of interactions, regardless of each user's affinity for a given object or object attribute. Thus, given a ranked list of one hundred users (for example) in an affinity group and the desired number of interactions as ten, simply selecting the top ten users as the audience will likely not meet the desired number of interactions. This can be due to factors such as costs to reach a user, drop-off rates of users, as well as random factors.

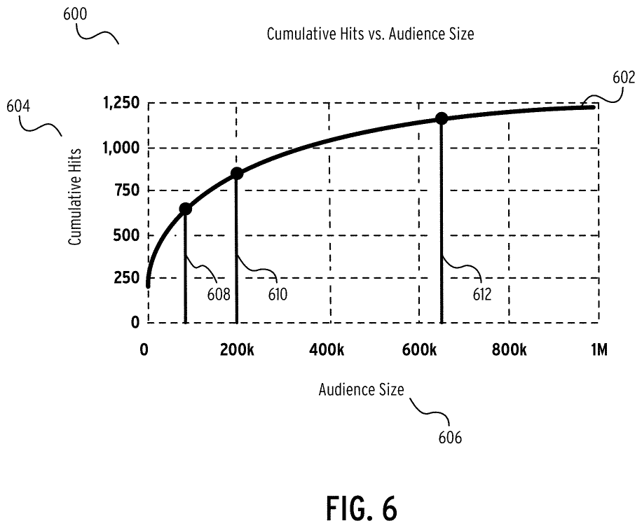

FIG. 6 is a chart illustrating learned recommended audience sizes that illustrates the above-described relationship between interactions and audience sizes.

The illustrated graph 600 visually depicts the relationship 602 between cumulative hits 604 and audience size 606. As illustrated, the relationship 602 depicts a natural maximum number of cumulative hits 604 (e.g., interactions) as approximately 1,250. In some embodiments, a percentage of hits (i.e., hit rate) may be used in lieu of a cumulative hits 604 value. As illustrated, relationship 602 is a (natural) logarithmic relationship, and thus increases in y-axis values (e.g., cumulative hits 604) are more dramatic at lower ends of the x-axis (e.g., audience size 606). That is, there is a tapering relationship between audience size and interactions (e.g., cumulative hits 604). Although the illustrated graph 600 is logarithmic, such a relationship is not presumed to exist yet a tapering effect remains.

In the illustrated embodiment, the first point 608 represents roughly half of the interactions observed in relationship 602 (approximately 625 interactions per 100,000 users), and second point 610 represents roughly 70% percent of the interactions (approximately 875 per 200,000 users). Thus, moving from first point 608 to second point 610 represents a 20% lift while only requiring a 100% increase (i.e., doubling) in audience size. By contrast, third point 612 represents roughly 90% percent of the interactions (approximately 1,125) but requires roughly 650,000 users. Thus, an equal 20% lift from 70% (second point 610) to 90% (third point 612) requires a 225% increase in audience size.

Thus, in the illustrated graph 600, for the first 200,000 users, the relationship 602 is steep, meaning for each additional user, a system can identify users at a relatively fast rate. As the audience size becomes larger, the relationship 602 begins to plateau, showing the increasing difficulty in identifying users when reaching larger audience sizes. When selecting, for example, the top ten users to include in an audience, there is a high degree of certainty and a strong signal. When a system attempts to identify millions of users, however, it has much less certainty and signal, making the problem increasingly challenging. The example embodiments solve this challenge as described in more detail below.

As will be discussed next, the example embodiments provide systems, methods and computer-readable media for generating curves similar to that depicted in FIG. 6 for a given object or object attribute and a set of users. The example embodiments further describe using such curves to predict one or more optimal or recommended audience sizes.

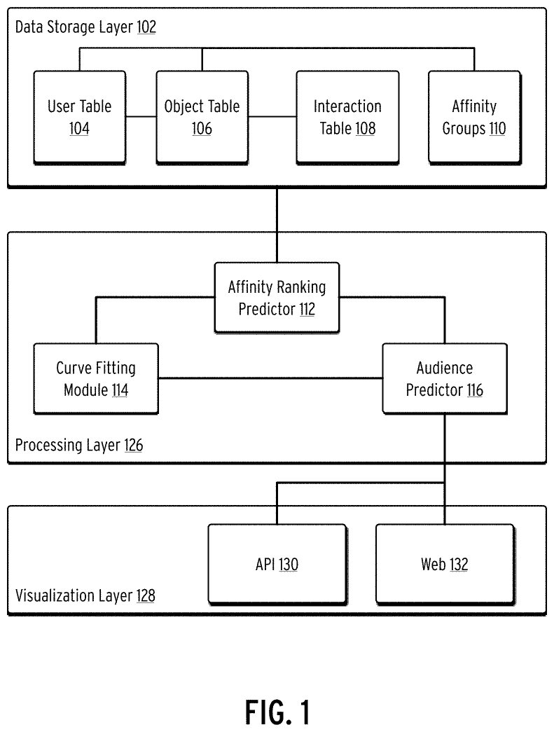

FIG. 1 is a system diagram illustrating a system for generating learned recommended audience sizes according to some embodiments.

In the illustrated embodiment, the system includes a data storage layer 102. The data storage layer 102 can comprise one or more databases or other storage technologies such as data lake storage technologies or other big data storage technologies. In some embodiments, the data storage layer 102 can comprise a homogenous data layer, that is, a set of homogeneous data storage resources (e.g., databases). In other embodiments, the data storage layer 102 can comprise a heterogeneous data layer comprising multiple types of data storage devices. For example, a heterogeneous data layer can comprise a mixture of relational databases (e.g., MySQL or PostgreSQL databases), key-value data stores (e.g., Redis), NoSQL databases (e.g., MongoDB or CouchDB), or other types of data stores. In general, the type of data storage devices in data storage layer 102 can be selected to best suit the underlying data. For example, user data can be stored in a relational database (e.g., in a table), while interaction data can be stored in a log-structured storage device. Ultimately, in some embodiments, all data may be processed and stored in a single format (e.g., relational). Thus, the following examples are described in terms of relational database tables; however, other techniques can be used.

In the illustrated embodiment, the data storage layer 102 includes a user table 104. The user table 104 can include any data related to users or individuals. For example, user table 104 can include a table describing a user. In some embodiments, the data describing a user can include at least a unique identifier, while the user table 104 can certainly store other types of data such as names, addresses, genders, etc.

In the illustrated embodiment, the data storage layer 102 includes an object table 106. The object table 106 can include details of objects tracked by the system. As one example, object table 106 can include a product table that stores data regarding products, such as unique identifiers of products and attributes of products. As used herein, an attribute refers to any data that describes an object. For example, a product can include attributes describing a brand name, size, color, etc. In some embodiments, attributes can comprise a pair comprising a type and a value. For example, an attribute may include a type (“brand” or “size”) and a value (“Adidas” or “small”). The example embodiments primarily describe operations on attributes or, more specifically, attribute values. However, the example embodiments can equally be applied to the “type” field of the attributes.

In the illustrated embodiment, the data storage layer 102 includes an interaction table 108. The interaction table 108 can comprise a table that tracks data representing interactions between users stored in user table 104 and objects stored in object table 106. In an embodiment, the data representing interactions can comprise fields such as a date of an interaction, a type of interaction, a duration of an interaction, a value of an interaction, etc. One type of interaction can comprise a purchase or order placed by a user stored in user table 104 for an object stored in object table 106. In an embodiment, the interaction table 108 can include foreign key references (or similar structures) to reference a given user stored in user table 104 and a given object stored in object table 106.

In some embodiments, the system can update data in the data storage layer 102 based on interactions detected by monitoring other systems (not illustrated). For example, an e-commerce website can report data to the system, whereby the system persists the data in data storage layer 102. In some embodiments, other systems can directly implement the system themselves. In other embodiments, other systems utilize an application programming interface (API) to provide data to the system.

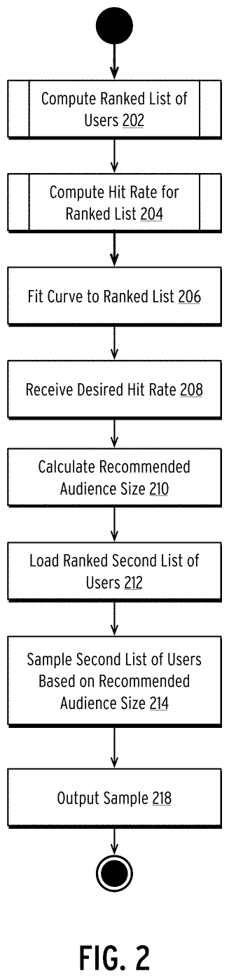

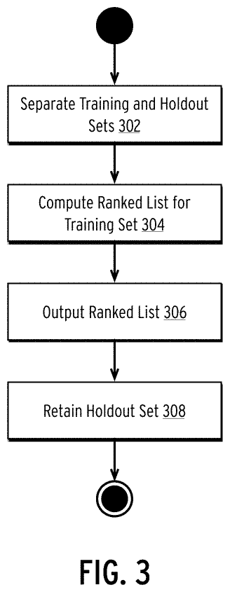

In the illustrated embodiment, the data storage layer 102 includes an affinity group table 110. In some embodiments, the affinity group table 110 can store a ranked list of users. In one embodiment, the affinity group table 110 can store a ranked list of users for each object or each object attribute. Details of generating ranked lists of users for object attributes are provided in step 202 of FIG. 2 and FIG. 3. Further detail on generating affinity group scores is provided in commonly owned application bearing attorney docket number 189943-011300/US.

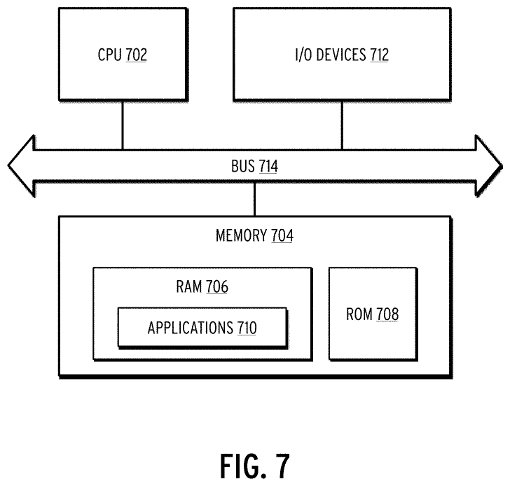

In the illustrated embodiment, the system includes a processing layer 126. In some embodiments, the processing layer 126 can comprise one or more computing devices (e.g., such as that depicted in FIG. 7) executing the methods described herein.

In the illustrated embodiment, the processing layer 126 includes an affinity ranking predictor 112. In the illustrated embodiment, the affinity ranking predictor 112 can be configured to generate ranked lists of users for each object or object attribute. Details of generating ranked lists of users for object attributes are provided in step 202 of FIG. 2, as well as FIG. 3. Further detail on generating affinity group scores is also provided in commonly owned application bearing attorney docket number 189943-011300/US.

In some embodiments, affinity ranking predictor 112 can additionally segment interaction data based on a cutoff date and use all interactions occurring before that cutoff date as a training set and a fixed range of interactions (e.g., the most recent one month) as a holdout data set. In an embodiment, the affinity ranking predictor 112 can generate a ranked list of users for the training set while using the holdout data for validation of the ranked list of users as described more fully in commonly owned application bearing attorney docket number 189943-011300/US. A ranked list of users based on a training dataset is referred to as a ranked training list of users. In the illustrated embodiment, the ranked training list of users can thus comprise a list of users and a corresponding hit rate for each ranked user. Specifically, for each user, the affinity ranking predictor 112 can compute a total amount of interactions with the given object or object attribute and divide this per-user total by the sum of all interactions to obtain a hit rate for a given user.

In an embodiment, the affinity ranking predictor 112 can additionally generate a ranked list of users based on an entire dataset. In such an embodiment, the affinity ranking predictor 112 does not segment data into training and holdout datasets. A ranked list of users based on an entire dataset is referred to as a ranked production list of users. In the illustrated embodiment, the affinity ranking predictor 112 may provide the ranked training list of users to curve fitting module 114 while providing the ranked production list of users to the audience predictor 116, as will be discussed in more detail herein. In some embodiments, the ranked production list of users can be generated after the ranked training list of users while in other embodiments, they may be computed simultaneously.

In the illustrated embodiment, curve fitting module 114 can be configured to receive the ranked training list of users and sample a plurality of segments of the ranked training list of users. As user herein a “segment” of the ranked training list of users refers to a fixed number of users selected from the ranked training list of users. In one embodiment, the curve fitting module 114 can use a stride value to iteratively select a larger and larger segment of the total number of users in the ranked training list of users. For example, if the ranked training list of users includes ten million users, the curve fitting module 114 can select the top one million, two million, three million, etc. users until selecting all ten million users. For each segment, curve fitting module 114 can compute a total number of interactions (e.g., hits) corresponding to a segment size. Thus, curve fitting module 114 can generate a series of two-dimensional points having the form (size, hits). Using these points, the curve fitting module 114 can then fit a curve or line to the set of points. Such a curve is depicted in FIG. 6. Various curve fitting techniques can be used including, without limitation, polynomial or linear regression, random consensus, among others.

The curve fitting module 114 provides fitted curves to an audience predictor 116. In the illustrated embodiment, the audience predictor 116 can first identify a desired audience size given a hit rate threshold. For example, an end user can specify that they would like a desired hit rate of 75%. In some embodiments, audience predictor 116 can convert the desired hit rate into a desired number of interactions. For example, audience predictor 116 can utilize the total number of interactions from the ranked training list of users and multiply the desired hit rate by the total number of interactions to obtain a desired number of interactions. Next, the audience predictor 116 can identify (using the desired number of interactions) the corresponding audience size on the fitted curve generated by curve fitting module 114 and output the recommended audience size.

After determining the recommended audience size, the audience predictor 116 can then load the ranked production list of users generated by affinity ranking predictor 112, as discussed previously. As discussed, the ranked production list of users is generated based on an entire available dataset of users (i.e., a dataset larger and potentially including the training set used to generate the ranked training list of users). After predicting the recommended audience size (n), the audience predictor 116 can select the top n users from the ranked production list of users and return those users as the recommended affinity group of users.

The above embodiments primarily discuss the use of a single desired hit rate and thus (a single recommended affinity group of users). However, the embodiments can operate on multiple desired hit rates and thus generate multiple recommended audience sizes and recommended affinity groups of users.

In the illustrated embodiment, the system includes a visualization layer 128 that can include, for example, an application API 130 and a web interface 132. In the illustrated embodiment, the components of the visualization layer 128 can retrieve the recommended affinity group of users from the audience predictor 116 and present the data or visualizations based on the data to end-users (not illustrated). For example, a mobile application or JavaScript front end can access application API 130 to generate local visualization of the recommended affinity group of users. As another example, web interface 132 can provide web pages built using the recommended affinity group of users (e.g., in response to end-user requests).

FIG. 2 is a flow diagram illustrating a method for generating learned recommended affinity group of users according to some of the example embodiments.

In step 202, the method can include computing a ranked list of users. The description of FIG. 3 includes further detail on step 202, and that description is not repeated herein. In an embodiment, a ranked list of users comprises a set of users of a system ordered by a pre-defined criterion. In an embodiment, the pre-defined criterion can comprise an affinity score for a given object or object attribute. In an embodiment, the affinity score can comprise an affinity group score as described, in more detail, in commonly owned application bearing attorney docket number 189943-011300/US. Other techniques for ranking users can be used provided that the pre-defined criterion is sortable. In some embodiments, the ranked list in step 202 can be computed using a training set which comprises a subset of the entire data of users and interactions, as described in more detail herein.

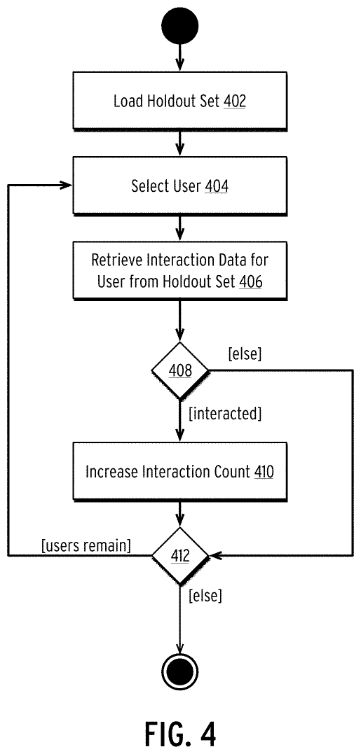

In step 204, the method can include computing a hit rate for the ranked list of users generated in step 204. The description of FIG. 4 includes further detail on step 204, and that description is not repeated herein. In brief, the method can load a holdout set of user interactions with a given object or object attribute and can compute interaction counts (e.g., hits) for each user. The method can sum the per-user hits as a label for the ranked list and may compute an average based on the sum and a total number of hits for an entire user base to obtain the hit rate. Thus, for example, if the computed sum for the rank list is 1000, and the number of interactions made by users in the recommended affinity group is 500, the hit rate can be computed as 0.5.

In step 206, the method can include fitting a curve or line to the ranked list of users. As described in the descriptions of FIG. 1 and FIG. 6, the method can compute a curve using an aggregate audience size as the x-axis and a hit rate or interaction count as the y-axis. As discussed in step 204, the interaction count or hit rate can be computed across a ranked list of users. To compute the aggregate audience size, the method can sample the ranked list of users starting at the highest ranked user and increasing the size of the sample by a fixed stride. Various curve fitting techniques can be used including, without limitation, polynomial or linear regression, random consensus, among others.

In an embodiment, the method can use a minimum audience size and maximum audience size. In such an embodiment, the method can step from the minimum audience size to the maximum audience size and select the desired number of users for the sample set. As one example, if the minimum audience size is one million and the maximum audience size is ten million (all users), the method can step from one to ten million in increments of one million, selecting one million, two million, three million, etc., users using a linear step function. In other embodiments, an exponential or logarithmic step function can be used. In some embodiments, every value between the minimum audience size and maximum audience size can be used to select the subset of users. However, a step function can be used to increase the speed at which sample sets are generated. In some embodiments, the minimum audience size can be one. In some embodiments, the maximum audience size may be all users in the ranked list. In some embodiments, the minimum audience size or maximum audience size can comprise values between one and the number of users in the ranked list. In the embodiments, the minimum audience size is less than the maximum audience size. In the embodiments, the stepped through audience segments are entirely overlapping. That is, segment n+m includes all users in segment n immediately preceding it while also including the next m ranked users. Thus, continuing the previous example of ten million users, the first step includes users 1 through 1,000,000 while the next step includes the users 1 through 2,000,000. After selecting the segment of users, the method can aggregate the number of interactions across the segment. Thus, in step 206, the method generates a series of two-dimensional points having the form (size, hits). While the example embodiments are described in two dimensions, the embodiments can be implemented in higher dimensions.

In step 208, the method can include receiving one or more desired hit rates. In an embodiment, an external user or external device can transmit a desired hit rate to the method. For example, the method can be executed as part of a network-based (e.g., cloud) service or similar service. In other embodiments, the method can be executed locally as a desktop or mobile application and a user can submit the desired hit rate using a user interface. In an embodiment, the desired hit rate can be expressed as a floating-point value (e.g., a percentage).

In step 210, the method can include calculating a recommended audience size. In some embodiments, the method can include converting a desired hit rate into a desired number of interactions. In an embodiment, the method can compute the total number of interactions used in the ranked list of users computed in step 202 and multiply the hit rate by the total number of interactions. Next, the method can use the total number of interactions as the y-value of a point on the curve fitted in step 208. Using this point, the method can identify the corresponding x-value (i.e., the cumulative audience size).

In step 212, the method can include loading a second ranked list of users. In some embodiments, this second ranked list of users can be computed in a manner similar to that described in step 304 of FIG. 3. However, in step 212, the second ranked list can be computed over all users and all interactions up to the current time. That is, the second ranked list of users does not exclude a holdout set.

In step 214, the method can include sampling the second ranked list of users based on the recommended audience size. In an embodiment, the method can select the top r users from the second ranked list, where r represents the recommended cumulative audience size generated in step 210.

In step 216, the method can include outputting sampled users from the second ranked list of users. In some embodiments, step 216 can comprise providing the sample set of users to a device via a network response (e.g., webpage, API response, etc.). In other embodiments, step 216 can comprise displaying the sample set of users via a locally running user interface.

FIG. 3 is a flow diagram illustrating a method for computing a ranked list of users according to some of the example embodiments.

In step 302, the method can include separating training and holdout sets of user data. As discussed above, in some embodiments, the user data can include demographic or other data of users, interaction data, and object data corresponding to interactions. In one embodiment, the method can separate data based on a preconfigured holdout period cutoff. For example, the method can reserve the latest thirty days of data as a holdout set and reserve the remaining data as the training set. In some embodiments, the method can limit the size of the training set to a fixed period (e.g., a fixed number of days). In some embodiments, the holdout set is referred to as test data.

In step 304, the method can include computing a ranked list for the training set. Details of generating such a ranked list are described more fully in commonly owned application bearing attorney docket number 189943-011300/US and are not repeated in full herein. In brief, the method can compute affinity scores for each object attribute. In one embodiment, the method can associate a given product attribute (e.g., brand, color, etc.) with a set of ranked users. Each of the ranked users is associated with a probability (e.g., a value between zero and one) that indicates the likelihood of the user interacting with (e.g., purchasing) an object (e.g., a product) that includes the attribute for a given forecasting window. An example of a ranked list of n users for a given attribute (e.g., a “type” attribute of “shoes”) is provided below:

TABLE 1

| Uᵢ | Attribute | Affinity Group Score |
|---|---|---|
| 1 | shoes | 0.4080 |
| 2 | shoes | 0.2380 |
| 3 | shoes | 0.1092 |
| 4 | shoes | 0.0472 |
| 5 | shoes | 0.0300 |
| 6 | shoes | 0.0260 |
| 7 | shoes | 0.0184 |

. . .

| | | |
|---|---|---|
| n | shoes | 0.0000 |

In some embodiments, the method can utilize an object recommendation model to generate object affinity groups. Specifically, in some embodiments, the method can utilize a Bayesian ranking approach to leverage object recommendations to generate object affinity groups. Such an approach maintains the internal consistency between object recommendations and affinity groups and shows significant improvement in the prediction performance.

In some embodiments, the method can utilize a classifier (e.g., a multinomial random forest classifier) to generate object recommendations for a given user. In an embodiment, the classifier outputs a ranked list of object attributes that the given user is likely to interact with over a forecasting period. Next, the method can compute the probability of the given user to interact with (e.g., purchase) any object over the same forecasting window. In an embodiment, the method can compute this probability using a geometric model (e.g., a beta-geometric model), which outputs the total number of expected interactions from a given user over the forecasting period. The method can then divide the total expected number of interactions for a given user by the total number of expected interactions across all users to obtain the probability that a given interaction will be from the given user. Finally, the method can multiply the output of the classifier by the predicted number of interactions to obtain the probability that a given user will interact with a given object or object attribute.

Reference is made to commonly owned application bearing attorney docket number 189943-011300/US for further detail on the above embodiments and additional embodiments. In general, however, any technique that can generate a list of ranked users for a given object or object attribute can be used.

In step 306, the method outputs the ranked list to the downstream steps. For example, step 204 can receive the list generated in step 304. Further, in step 308, the method can comprise temporarily storing the holdout set in, for example, memory or in a temporary disk location for future processing. In some embodiments, the future processing can comprise step 204 of FIG. 2 or step 402 of FIG. 4, as discussed next.

In some embodiments, the method of FIG. 3 can be modified to execute the operations of step 212 in FIG. 2. Specifically, step 302 can be eliminated, and an entire dataset can be used to generate a ranked list in step 304. Further, in step 212, step 308 can be omitted.

FIG. 4 is a flow diagram illustrating a method for computing hit rate for a sample set according to some embodiments of the example embodiments.

In step 402, the method can include loading a holdout set. In an embodiment, the holdout set comprises data recorded during a most recent period of time. For example, data recorded during the last thirty days can be loaded as the holdout set. In an embodiment, the holdout set may be pre-stored via a ranking process such as that depicted in FIG. 2.

In step 404, the method can include selecting a given user. In an embodiment, the method can select the given user from a ranked list of users. In an embodiment, the ranked list of users can comprise the ranked list of users generated in step 304 of FIG. 3. In an embodiment, the method can iteratively select each user in the ranked list. In some embodiments, the method can iteratively select users based on their corresponding affinity group score. For example, the method selects a user having the highest affinity group score, then the user having the second-highest affinity group score, third-highest affinity group score, etc.

In step 406, the method can include retrieving interaction data from the holdout set for the given user selected in step 404. In one embodiment, the holdout set can be stored relationally (as discussed in FIG. 1). Thus, in step 406, the method can include querying a relational database to load all interaction data for the given user selected in step 404. In some embodiments, various filters can be used to filter the returned data. For example, the method can filter duplicate interactions or filter interactions not meeting minimum constraints (e.g., purchase price, duration, etc.).

In the illustrated embodiment, the method can only retrieve interaction data that is associated with a given object or object attribute. For example, in some embodiments, the method of FIG. 4 can be executed for a single object or object attribute. As an example, the method can be executed for all interactions with an attribute of “shoe” (e.g., corresponding to Table 1). Thus, in the illustrated embodiment, in step 406, the method retrieves all interactions for a given user selected in step 404 and a selected object or object attribute.

In some embodiments, the interaction data can be pre-processed in parallel. For example, in some embodiments, while the method of FIG. 3 computes the ranked list of users in step 304, and the method can simultaneously pre-process the holdout set. In some embodiments, pre-processing can comprise aggregating individual users' interactions in composite records. For example, the method can group all interactions for each user and compute aggregate values for each (e.g., the total number of interactions). Thus, for example, the method can store only a user identifier and a total number of interactions in a key-value store or another data store that provides rapid random access. In some embodiments, step 406 can then comprise querying the key-value store using a user identifier and immediately receiving the total number of interactions.

In step 408, the method can include determining if any interactions were identified in step 406. In some scenarios, the given user selected in step 404 may not have interacted with a given object or object attribute during the holdout period associated with the holdout data set. If so, the method can bypass step 410 (discussed herein) and proceed directly to step 414.

In step 410, however, if the method determines that the given user selected in step 404 is associated with an interaction involving the object or object attribute, the method can increase the total number of interactions associated with the object or object attribute.

In one embodiment, the method maintains a count of interactions with a given object or object attribute. Prior to executing the method of FIG. 4, this count can be initialized to zero. In step 410, the method increments the count each time a given user selected in step 404 is associated with an interaction with the object or object attribute. In one embodiment, the method can comprise incrementing the count by one in step 410 regardless of how many interactions are associated with the given user selected in step 404. Thus, in some embodiments, the count represents how many users in the ranked list have interacted with a given object or object attribute. In other embodiments, the method can increment the count by the number of interactions detected in step 410. In this embodiment, the count represents the total number of interactions across all users.

In step 412, the method can include determining if any users remain to be analyzed. If so, the method re-executes step 404, step 406, step 408, and step 410 for each remaining user.

After step 412, the method ends and can output the list of ranked users augmented with interaction counts. In some embodiments, the method can further compute a percentage of interactions for the entire holdout set and a total of all interactions for all users, as described previously

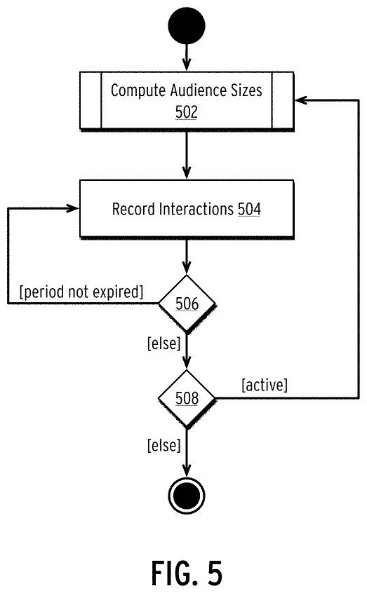

FIG. 5 is a flow diagram illustrating a method for continuously updating learned recommended audience sizes according to some of the example embodiments.

In step 502, the method can include computing audience sizes for one or more sample sets of ranked users. Details of this process are described in the description of FIGS. 2 through 4 and are not repeated herein.

In step 504, the method can include recording the interactions of users. In the illustrated embodiment, the method can continuously record interactions of users with objects and object attributes before, during, and (as illustrated) after generating audience sizes using the methods of FIGS. 2 and 4. Thus, in some embodiments, the method can compute an audience size (e.g., the smallest audience size meeting a hit rate threshold) and then continue to record interactions of users with the object or object attribute used to generate the audience size.

In step 506, the method can include determining if a period has expired. In an embodiment, the period can comprise a fixed period to record interactions (e.g., one month). In other embodiments, the period can comprise a number of desired interactions to reach. In general, step 506 can comprise a triggering condition that causes the system to recompute hit rates automatically rather than requiring requests for audience sizes. If the period has not expired (or a target number of interactions is reached), the method can continue to record interactions in step 504 until the period expires (or a target number of interactions is reached).

In step 508, the method determines if real-time audience size generation is active. In some embodiments, step 508 can be used to terminate the method. That is, if the method determines that the real-time audience size generation is active, it will continuously re-execute step 502 for each period determined in step 506. Alternatively, if real-time audience size generation is not active, the method will end.

In the illustrated embodiment, by using a real-time process, the method can continuously update the recommended audience size. In some embodiments, the period determined in step 506 can be adjustable as the method executes. Thus, for example, during a time period with more interactions (e.g., winter for an object such as a coat or scarf), the period can be reduced to increase the number of predictions over time. Conversely, during a time period with fewer interactions (e.g., summer for an object such as a coat or scarf), the period can be increased to decrease the number of predictions over time.

FIG. 7 is a block diagram of a computing device according to some embodiments of the disclosure. In some embodiments, the computing device can be used to train and use the various ML models described previously.

As illustrated, the device includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In an embodiment, the bus 714 may comprise a Peripheral Component Interconnect Express (PCIe) bus. In some embodiments, bus 714 may comprise multiple busses instead of a single bus.

Memory 704 illustrates an example of computer storage media for the storage of information such as computer-readable instructions, data structures, program modules, or other data. Memory 704 can store a basic input/output system (BIOS) in read-only memory (ROM), such as ROM 708, for controlling the low-level operation of the device. The memory can also store an operating system in random-access memory (RAM) for controlling the operation of the device

Applications 710 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In an embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein. Example embodiments are provided merely to be illustrative. Likewise, the reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order. For example, two blocks shown in succession can, in fact, be executed substantially concurrently, or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, cloud storage, magnetic cassettes, magnetic tape, magnetic disk storage, or other magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
receiving a first set of users associated with an object attribute by querying a first data source storing affinity groups of users for corresponding object attributes;
computing hit rates for the first set of users by querying a second data source of user interactions with objects, a respective hit rate in the hit rates computed by calculating a total number of interactions associated with a respective user in the second data source during a holdout period;
fitting a curve based on a plurality of segments of the first set of users, each segment in the segments associated with an aggregate number of interactions, wherein a given segment in the segments is represented as a tuple comprising an aggregate hit rate for a subset of the first set of users and a size of the subset of the first set of users;
receiving, over a network, a request for a recommended audience size, the request including a desired hit rate;
computing the recommended audience size based on the curve and the desired hit rate, wherein the recommended audience size comprises a point on the curve associated with the desired hit rate; and
selecting a subset of users from a second set of users stored in a third data source, the subset selected based on the recommended audience size and the curve.

2. The method of claim 1, wherein receiving the first set of users comprises receiving a ranked set of users.

3. The method of claim 2, wherein receiving the ranked set of users comprises receiving a set of users ranked by affinity group scores associated with each user in the set of users, a respective affinity group score associating a respective user to a respective object.

4. The method of claim 1, further comprising generating the first set of users by:
separating a set of interactions into a training set and a holdout set based on a point in time;
ranking a set of users based on interactions in the training set; and
temporarily storing the holdout set.

5. The method of claim 1, wherein computing a recommended audience size based on the curve and a desired hit rate comprises:
selecting a plurality of segments of the first set of users;
calculating a total number of hits for each of the segments; and
using sizes of the plurality segments and corresponding total numbers of hits as points on the curve.

6. The method of claim 5, wherein selecting the plurality of segments comprises selecting the plurality of segments according to a step function.

7. The method of claim 6, wherein the plurality of segments are overlapping and increasing in size as selected using the step function.

8. A non-transitory computer-readable storage medium for tangibly storing computer program instructions capable of being executed by a computer processor, the computer program instructions defining steps of:
receiving a first set of users associated with an object attribute by querying a first data source storing affinity groups of users for corresponding object attributes;
computing hit rates for the first set of users by querying a second data source of user interactions with objects, a respective hit rate in the hit rates computed by calculating a total number of interactions associated with a respective user in the second data source during a holdout period;
fitting a curve based on a plurality of segments of the first set of users, each segment in the segments associated with an aggregate number of interactions, wherein a given segment in the segments is represented as a tuple comprising an aggregate hit rate for a subset of the first set of users and a size of the subset of the first set of users;
receiving, over a network, a request for a recommended audience size, the request including a desired hit rate;
computing the recommended audience size based on the curve and the desired hit rate, wherein the recommended audience size comprises a point on the curve associated with the desired hit rate; and
selecting a subset of users from a second set of users stored in a third data source, the subset selected based on the recommended audience size and the curve.

9. The non-transitory computer-readable storage medium of claim 8, wherein receiving the first set of users comprises receiving a ranked set of users.

10. The non-transitory computer-readable storage medium of claim 9, wherein receiving the ranked set of users comprises receiving a set of users ranked by affinity group scores associated with each user in the set of users, a respective affinity group score associating a respective user to a respective object.

11. The non-transitory computer-readable storage medium of claim 8, the steps further comprising generating the first set of users by:
separating a set of interactions into a training set and a holdout set based on a point in time;
ranking a set of users based on interactions in the training set; and
temporarily storing the holdout set.

12. The non-transitory computer-readable storage medium of claim 8, wherein computing a recommended audience size based on the curve and a desired hit rate comprises:
selecting a plurality of segments of the first set of users;
calculating a total number of hits for each of the segments; and
using sizes of the plurality segments and corresponding total numbers of hits as points on the curve.

13. The non-transitory computer-readable storage medium of claim 12, wherein selecting the plurality of segments comprises selecting the plurality of segments according to a step function.

14. The non-transitory computer-readable storage medium of claim 13, wherein the plurality of segments are overlapping and increasing in size as selected using the step function.

15. A device comprising:
a processor configured to:
receive a first set of users associated with an object attribute by querying a first data source storing affinity groups of users for corresponding object attributes,
compute hit rates for the first set of users by querying a second data source of user interactions with objects, a respective hit rate in the hit rates computed by calculating a total number of interactions associated with a respective user in the second data source during a holdout period,
fit a curve based on a plurality of segments of the first set of users, each segment in the segments associated with an aggregate number of interactions, wherein a given segment in the segments is represented as a tuple comprising an aggregate hit rate for a subset of the first set of users and a size of the subset of the first set of users,
receive, over a network, a request for a recommended audience size, the request including a desired hit rate,
compute the recommended audience size based on the curve and the desired hit rate, wherein the recommended audience size comprises a point on the curve associated with the desired hit rate, and
select a subset of users from a second set of users stored in a third data source, the subset selected based on the recommended audience size and the curve.

16. The device of claim 15, wherein receiving the first set of users comprises receiving a ranked set of users.

17. The device of claim 15, the processor further configured to generating the first set of users by:
separating a set of interactions into a training set and a holdout set based on a point in time;
ranking a set of users based on interactions in the training set; and
temporarily storing the holdout set.

18. The device of claim 15, wherein computing a recommended audience size based on the curve and a desired hit rate comprises:
selecting a plurality of segments of the first set of users;
calculating a total number of hits for each of the segments; and
using sizes of the plurality segments and corresponding total numbers of hits as points on the curve.

19. The device of claim 18, wherein selecting the plurality of segments comprises selecting the plurality of segments according to a step function.

20. The device of claim 19, wherein the plurality of segments are overlapping and increasing in size as selected using the step function.
